(19) United States
(12) Patent Application Publication
(10) Pub. No.: US 2011/0307120 A1
(43) Pub. Date: Dec. 15, 2011

(54) METHOD FOR LOCATING THE LONGITUDINAL POSITION OF THE WHEELS OF A VEHICLE

(75) Inventors: Youri Vassilieff, Toulouse (FR); Jeremy Armengaud, Saverdun (FR)

(73) Assignee: CONTINENTAL AUTOMOTIVE FRANCE, Toulouse (FR)

(21) Appl. No.: 13/140,844

(22) PCT Filed: Dec. 3, 2009
(86) PCT No.: PCT/EP09/08620

§ 371 Date: Aug. 23, 2011

(30) Foreign Application Priority Data
Dec. 19, 2008 (FR) 0807150

(51) Int. Cl. B60C 23/04; B62D 15/02

(52) U.S. Cl. 701/1

(57) ABSTRACT

A method for locating the longitudinal position, either on the front chassis or on the rear chassis of a vehicle, of wheels (2) equipped with an electronic module (6) (or called wheel unit) designed to emit, to a central processing unit mounted on the vehicle, signals representative of operating parameters of each wheel. Each wheel (2) is equipped with a sensor (16) for measuring values representative of the norm of the Earth's magnetic field projected into the plane of the wheel, series of values measured simultaneously by the various sensors (16), representative of the variations of the norm of the Earth's magnetic field measured by each of the sensors, are compared so as to reveal a phase shift between the series, and the guiding wheels (2) are identified as being the wheels equipped with the sensors (16) originating the series of values in phase advance.

The invention relates to a method for locating the longitudinal position, either on the front chassis or on the rear chassis of a vehicle, of wheels equipped with an electronic module (called wheel unit) designed to emit, to a central processing unit mounted on the vehicle, signals representative of operating parameters of each wheel and which also comprise an identification code for identifying said wheel.

More and more motor vehicles are fitted, for safety purposes, with monitoring systems comprising sensors mounted on each of the wheels of the vehicle, dedicated to measuring parameters, such as pressure or temperature of the tires fitted on these wheels, and intended to inform the driver of any abnormal variation of the measured parameter.

These monitoring systems are conventionally provided with an electronic module mounted on each of the wheels of the vehicle, incorporating, in addition to the abovementioned sensors, a microprocessor and a radio frequency emitter (or RF emitter), and with a central processing unit for receiving the signals emitted by the emitters, comprising a computer incorporating a radio frequency receiver (or RF receiver) connected to an antenna.

One of the problems that has to be resolved in such monitoring systems lies in the obligation to have to associate with each signal received by the receiver of the central processing unit, an information item regarding the location of the electronic module and therefore of the wheel originating this signal, this obligation remaining throughout the life of the vehicle, that is to say, having to be observed even after wheel changes or more simply reversals of the positions of these wheels.

Currently, a first locating method consists in incorporating an accelerometer in each electronic module, and in applying a locating technique based on statistical methods consisting in comparing the accelerations of the various wheels to obtain an information item on the respective position of each of said wheels.

However, this locating method has proved inefficient because it requires a significant running time in order to discriminate between the different wheels.

A second locating method consists in using three low-frequency antennas each positioned in proximity to one of the wheels of the vehicle, and in performing a locating procedure which consists in successively exciting each of these three antennas by the emission of a low-frequency magnetic field.

According to this procedure, the electronic module (wheel unit) mounted on the wheel situated in proximity to the excited antenna emits, in response and addressed to the central processing unit, a low-frequency signal comprising an identification code for identifying said module, so that the successive excitation of the three antennas leads to the locating of the three electronic modules mounted on the wheels adjacent to these antennas, and by deduction, to the locating of the fourth module.

The main advantage of such a method lies in the fact that the locating procedure is very rapid and leads to an almost instantaneous locating after the vehicle has started.

However, this solution is very costly because it requires the vehicle to be equipped with three antennas with all the attendant constraints: connecting cables, control amplifiers, etc.

A third locating method consists in determining the positioning of the wheels on the basis of a comparison of the intensity of the signals received by the central processing unit, originating from each emitter. As notably described in the patent EP 0 931 679, this method consists:
in a preliminary phase, in programming the central processing unit so as to create, from the envelope of the amplitude of the signal received from each emitter, a signature of this signal, then in storing in said central processing unit each signature and the corresponding position of the wheel,
and following this preliminary phase, in establishing locating phases of the wheels consisting in creating, in the central processing unit, the signatures of the signals received from the emitters, and in comparing each signature with the stored signatures so as to deduce therefrom the position of the corresponding wheel.

It so happens, however, that the envelope of the amplitude of the signals received from each emitter may undergo alterations according to road conditions, and notably be altered by a wet road, in the presence of metallic elements such as a safety rail, when running in a tunnel etc. The result of this, in practice, is that this locating method may require significant running times in order to discriminate between the different wheels.

As for the present invention, its aim is a fourth method dedicated to the locating of the longitudinal position (front chassis or rear chassis) of the wheels of a vehicle, and its main objective is to provide a locating method that is very efficient in terms of responsiveness and reliability, whose implementation generates a low overall cost price.

To this end, the invention targets a method for locating the longitudinal position, either on the front chassis or on the rear chassis, of wheels of a vehicle, consisting in equipping each wheel with a sensor for measuring values representative of the norm of the Earth's magnetic field projected into the plane of said wheel, in comparing series of values measured simultaneously by the various sensors, representative of the variations from the norm of the Earth's magnetic field measured by each of said sensors, so as to reveal a phase shift between said series, and in locating the guiding wheels as being the wheels equipped with the sensors originating the series of values in phase advance.

The invention therefore consisted, in an original manner, in exploiting the fact that, on each change of direction of a vehicle, on the one hand, the orientation of the plane of each wheel relative to magnetic north varies, and on the other hand, the changes of direction affect firstly the guiding wheels, then, secondly, with a certain time offset or phase shift, the non-guiding wheels. On the basis of this observation, the invention consists in:
implementing a locating technique based on the measurement, on each wheel, of the norm of the Earth's magnetic field projected into the plane of said wheel,
revealing that the signals delivered by the measurement means positioned on the wheels of one and the same chassis, front or rear, are substantially in phase, and that the signals delivered by the measurement means positioned on the guiding wheels are in phase advance relative to the signals delivered by the measurement means positioned on the non-guiding wheels.

Such a technique has proven very efficient in terms of responsiveness because, with it, a location of the longitudinal position of the wheels can be obtained after only a few changes of direction, after the vehicle has started.

According to one advantageous implementation of the invention, in order to mitigate the performance dispersions of the measurement sensors, relative values are determined for the comparisons of measured values, by means of a compensation method for taking into account the gain differences of the various measurement sensors.

Furthermore, for this taking into account of the gain differences of the various measurement sensors, a preliminary learning step is advantageously carried out, which consists in determining the gain of each sensor when the vehicle is moving in a straight line.

Moreover, the method according to the invention can be implemented by means of any type of suitable sensor positioned so as to provide values representative of the norm of the Earth's magnetic field projected into the plane of the wheel equipped with said sensor.

Thus, the invention can notably be implemented by means of sensors such as Hall-effect sensors, GMRs, designed to directly provide values representative of the magnetic field and therefore insensitive to the rotation speed of the wheels.

However, in order to optimize the cost price of the sensors, and advantageously according to the invention:
each wheel is equipped with a sensor consisting of a coil extending in the plane of said wheel, capable of delivering a signal representative of the drift of the Earth's magnetic field,
and said signal is converted so as to obtain a signal representative of the norm of the Earth's magnetic field.

Such coils in fact have a significantly advantageous cost price compared to that of the other types of sensors. However, these coils provide values representative of the drift of the Earth's magnetic field, that is to say values that vary notably proportionally relative to the rotation speed of the wheel concerned. Since the rotation speeds of the wheels of a vehicle are different (speeds of the inside wheels, in a bend, less than the speed of the outside wheels), the method according to the invention therefore consisted in eliminating the influence of these rotation speeds by converting the signal provided by each coil, advantageously:
either by integration,
or by a compensation method for taking into account the rotation speed differences of the wheels based on the calculation of the rotation speeds of each wheel or, at the very least, the calculation of the rotation speed differences. This calculation can be performed by the central processing unit mounted on the vehicle provided that the latter is provided with data concerning the angle of the steering wheel and the speed of the vehicle. This calculation can also be performed on each wheel by measuring the periodicity of the curve representative of the drift of the Earth's magnetic field provided by each coil.

According to another advantageous implementation, in order to reveal the phase shift between the series of measured values, series of values that vary strictly monotonically are selected, then, for the comparison of said series of values, either a value from each series measured at one and the same given instant, or the average value of each series of values, is selected.

This advantageous implementation leads to the use of a very simple rule for determining the phase shift between the series of measured values, said rule consisting:
when the series of values obtained for the four wheels are all strictly decreasing, in locating the guiding wheels as being the wheels equipped with the sensors originating the series having the lowest selected value (measured value or average value),
and when the series of values obtained for the four wheels are all strictly increasing, in locating the guiding wheels as being the wheels equipped with the sensors originating the series having the highest selected value.

Moreover, in order to give maximum reliability to the locating method, and advantageously according to the invention, values representative of the angle of the steering wheel of the vehicle are measured, and said measured values are compared with values representative of the turn angle of the wheels, so as to condition the validation of the series of measured values to a correlation between the steering wheel angle values and the turn angle values.

Other features, aims and advantages of the invention will emerge from the following detailed description with reference to the appended drawings which represent, as a nonlimiting example, a preferred embodiment thereof. In these drawings:

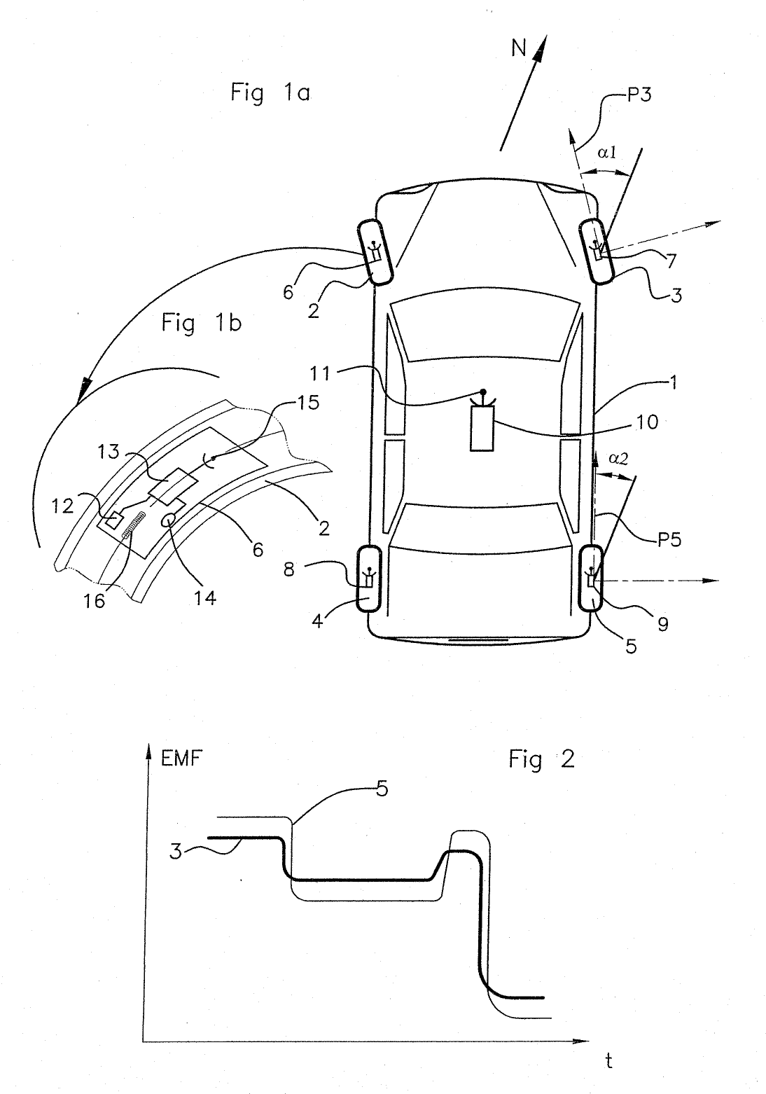

FIG. 1a is a schematic plan view of a vehicle provided with a monitoring system associated with a device according to the invention for locating the longitudinal position of the wheels of said vehicle,

FIG. 1b is a schematic detail view in perspective representing a portion of a wheel of this vehicle and the electronic module with which the latter is equipped,

FIG. 2 is a comparative graph of two signals delivered by measurement means set up respectively on a front wheel (thick line) and on a rear wheel (thin line).

The locating device according to the invention represented as an example in figures la and lb is intended for the locating of the longitudinal position (front wheel or rear wheel) of wheels of a vehicle.

This locating device is more specifically intended to be installed on vehicles provided with a monitoring system such as the one, represented in figure la, fitted in a vehicle 1 provided with four wheels conventionally clad with a tire: two front guiding wheels 2, 3 and two rear wheels 4, 5.

Such monitoring systems conventionally comprise, firstly, associated with each wheel 2-5, an electronic module 6-9, for example secured to the rim of said wheel so as to be positioned within the jacket of the tire.

As represented in FIG. 1b, each of these electronic modules 6-9 incorporates, for example, sensors 12 dedicated to measuring parameters such as pressure and/or temperature of the tire, connected to a microprocessor-based computation unit 13 electrically powered by means of a button cell 14, and linked to an RF emitter connected to a high-frequency antenna 15.

The monitoring system also comprises a centralized computer or central processing unit 10 located in the vehicle 1, comprising a microprocessor, and incorporating an RF receiver connected to an antenna 11 and capable of receiving the signals emitted by each of the four electronic modules 6-9.

Usually, such a monitoring system and notably its central processing unit 10, are designed to inform the driver of any abnormal variation of the parameters measured by the sensors 12 associated with the wheels 2-5.

Associated with this monitoring system and forming an integral part of the latter, the function of the locating device according to the invention is to make it possible to associate, with each signal received by the central processing unit 10, an information item concerning the longitudinal position of the wheel 2-5 equipped with the electronic module 6-9 originating this signal.

To this end, this locating device comprises measurement means consisting, in the example, of a coil 16 which is incorporated in each electronic module 6-9 and positioned so as to extend in the plane of symmetry, for example plane P3 or P5 as represented in FIG. 1a, of the wheel (wheel 3 or 5 according to FIG. 1a) equipped with said electronic module.

Such a coil 16 provides a signal representative of the variations over time of the drift of the norm of the Earth's magnetic field projected into the plane P3 or P5 of the wheel 3 or 5 equipped with said coil, that is to say, a signal representative of the variations of the angle α1 (for the front wheels 2, 3) or α2 (for the rear wheels 4, 5) extending between the direction (N) of magnetic north and the plane P3, P5 of the wheel.

According to the inventive method and firstly, the signal provided by each coil 16 is integrated so as to obtain values representative of the variations of the norm of the Earth's magnetic field in the plane P3, P5 of the wheel, which values notably exhibit the particular feature of being independent of the rotation speed of said wheel.

Given that no calibration can be applied to the coils 16, the values previously obtained by integration are then converted into relative values by means of a compensation method for taking into account the gain differences of the various coils 16.

To this end, learning steps are advantageously carried out periodically, consisting in determining the value of the signal provided by each coil 16 when the vehicle 1 is moving in a straight line, then in performing a comparison of these values directly representative of the gain difference of the various coils 16.

Once these relative values have been calculated, the next step consists in locating the guiding wheels 2, 3 by comparing the relative values provided by the various coils 16.

This location is obtained by exploiting the fact that the changes of direction affect firstly the guiding wheels 2, 3, then, secondly, with a certain time offset or phase shift, the non-guiding wheels 4, 5. This time offset or phase shift clearly emerges from the graph of FIG. 2 which represents respectively a signal obtained from a coil 16 fitted on a guiding wheel (front wheel 3), in phase advance relative to the signal obtained from a coil 16 fitted on a non-guiding wheel (rear wheel 5).

A very simple rule for determining this phase shift consists in comparing series of values measured simultaneously by the coils 16 fitted on the four wheels 2-5, and, more specifically, firstly, in selecting series of values that vary strictly monotonically, then in selecting, for the comparison of said series of values, either a value from each series measured at one and the same given instant, or the average value of each series of values, and
when the series of values obtained for the four wheels 2-5 are all strictly decreasing, in locating the guiding wheels 2, 3 as being the wheels equipped with the coils 16 originating the series that have the lowest selected value (measured value or average value),
when the series of values obtained for the four wheels 2-5 are all strictly increasing, in locating the guiding wheels 2, 3 as being the wheels equipped with the coils 16 originating the series that have the highest selected value.

The locating method according to the invention described hereinabove therefore makes it possible, provided that measurement means such as a simple coil 16 are installed in each electronic module 6-9 fitted to a wheel 2-5 of a vehicle 1, to very rapidly and reliably locate the longitudinal position of said wheel.

1. A method for locating the longitudinal position, either on the front chassis or on the rear chassis of a vehicle (1), of wheels (2-5) equipped with an electronic module (6-9) designed to emit, to a central processing unit (10) mounted on the vehicle (1), signals representative of operating parameters of each wheel and which also comprise an identification code for identifying said wheel, said locating method being characterized in that it consists in equipping each wheel (2-5) with a sensor (16) for measuring values representative of the norm of the Earth's magnetic field projected into the plane (P3, P5) of said wheel, in comparing series of values measured simultaneously by the various sensors (16), representative of the variations from the norm of the Earth's magnetic field measured by each of said sensors, so as to reveal a phase shift between said series, and in locating the guiding wheels (2, 3) as being the wheels equipped with the sensors (16) originating the series of values in phase advance.

2. The locating method as claimed in claim 1, characterized in that relative values are determined for the comparisons of the measured values, by means of a compensation method for taking into account the gain differences of the various measurement sensors (16).

3. The locating method as claimed in claim 2, characterized in that, for the taking into account of the gain differences of the various measurement sensors (16), a preliminary learning step is carried out, which consists in determining the gain of each measurement sensor (16) when the vehicle (1) is moving in a straight line.

4. The locating method as claimed in claim 1, characterized in that each wheel (2-5) is equipped with a sensor consisting of a coil (16) extending in the plane (P3, P5) of said wheel, capable of delivering a signal representative of the drift of the Earth's magnetic field, and in that said signal is converted so as to obtain a signal representative of the norm of the Earth's magnetic field.

5. The locating method as claimed in claim 4, characterized in that the signal supplied by each coil (16) is converted by integration.

6. The locating method as claimed in claim 4, characterized in that the signal supplied by each coil (16) is converted by a compensation method for taking into account the rotation speed differences of the wheels (2-5).

7. The locating method as claimed in claim 1, characterized in that:
series of values that vary strictly monotonically are selected,
and, for the comparison of said series of values, either a value from each series measured at one and the same given instant, or the average value of each series of values, is selected.

8. The locating method as claimed in claim 1, characterized in that values representative of the angle of the steering wheel of the vehicle (1) are measured, and in that said measured values are compared with values representative of the turn angle of the wheels (2-5), so as to condition the validation of the series of measured values to a correlation between the steering wheel angle values and the turn angle values.

9. The locating method as claimed in claim 2, characterized in that each wheel (2-5) is equipped with a sensor consisting of a coil (16) extending in the plane (P3, P5) of said wheel, capable of delivering a signal representative of the drift of the Earth's magnetic field, and in that said signal is converted so as to obtain a signal representative of the norm of the Earth's magnetic field.

10. The locating method as claimed in claim 3, characterized in that each wheel (2-5) is equipped with a sensor consisting of a coil (16) extending in the plane (P3, P5) of said wheel, capable of delivering a signal representative of the drift of the Earth's magnetic field, and in that said signal is converted so as to obtain a signal representative of the norm of the Earth's magnetic field.

11. The locating method as claimed in claim 9, characterized in that the signal supplied by each coil (16) is converted by integration.

12. The locating method as claimed in claim 10, characterized in that the signal supplied by each coil (16) is converted by integration.

13. The locating method as claimed in claim 9, characterized in that the signal supplied by each coil (16) is converted by a compensation method for taking into account the rotation speed differences of the wheels (2-5).

14. The locating method as claimed in claim 10, characterized in that the signal supplied by each coil (16) is converted by a compensation method for taking into account the rotation speed differences of the wheels (2-5).
